(19) United States
(12) Patent Application Publication
(10) Pub. No.: US 2025/0161921 A1
(43) Pub. Date: May 22, 2025

(54) NICKEL-NICKEL ALUMINUM SPINEL-CALCIUM HEXAALUMINATE COMPOSITE CATALYST AND PREPARATION METHOD AND USE THEREOF

(71) Applicant: Lanzhou Institute of Chemical Physics, CAS, Lanzhou City (CN)

(72) Inventors: Huahua Zhao, Lanzhou City (CN); Wenzheng Zhang, Lanzhou City (CN); Lingjun Chou, Lanzhou City (CN); Huanling Song, Lanzhou City (CN); Jian Yang, Lanzhou City (CN); Jun Zhao, Lanzhou City (CN); Liang Yan, Lanzhou City (CN)

(73) Assignee: Lanzhou Institute of Chemical Physics, CAS, Lanzhou City (CN)

(21) Appl. No.: 18/593,273

(22) Filed: Mar. 1, 2024

(30) Foreign Application Priority Data
Nov. 22, 2023 (CN) 2023115594798

(51) Int. Cl. B01J 23/755; B01J 23/00; B01J 23/02; B01J 37/00; B01J 37/04; B01J 37/08; B01J 37/18; C01B 3/40

(52) U.S. Cl. CPC B01J 23/755; B01J 23/005; B01J 23/02; B01J 37/0036; B01J 37/0045; B01J 37/04; B01J 37/088; B01J 37/18; C01B 3/40; C01B 2203/0238; C01B 2203/1058; C01B 2203/1082; C01B 2203/1241

(57) ABSTRACT

Provided are a nickel-nickel aluminum spinel-calcium hexaaluminate composite catalyst and a preparation method and use thereof. The method for preparing the nickel-nickel aluminum spinel-calcium hexaaluminate composite catalyst includes: mixing a nickel salt metal precursor, an aluminum salt metal precursor, a calcium salt metal precursor, and an organic fuel to obtain a mixed precursor; drying and calcining the mixed precursor sequentially to obtain a nickel aluminum spinel-calcium hexaaluminate composite precursor; and placing the nickel aluminum spinel-calcium hexaaluminate composite precursor in a flowing hydrogen atmosphere, and subjecting the nickel aluminum spinel-calcium hexaaluminate composite precursor to reduction reaction to obtain the nickel-nickel aluminum spinel-calcium hexaaluminate composite catalyst.

### CROSS REFERENCE TO RELATED APPLICATION

This application claims the benefit and priority of Chinese Patent Application No. 2023115594798 entitled “NICKEL-NICKEL ALUMINUM SPINEL-CALCIUM HEXAALUMINATE COMPOSITE CATALYST AND PREPARATION METHOD AND USE THEREOF” filed with the China National Intellectual Property Administration on Nov. 22, 2023, the disclosure of which is incorporated by reference herein in its entirety as part of the present application.

### TECHNICAL FIELD

The present disclosure relates to the technical field of dry reforming of methane (CH₄) to prepare syngas, and in particular relates to a nickel-nickel aluminum spinel-calcium hexaaluminate composite catalyst and a preparation method and use thereof.

### BACKGROUND

Natural gas is not only a power energy source, but also an important chemical raw material. The preparation of methanol, formaldehyde, ethylene, hydrogen, and syngas from natural gas is an important way for large-scale chemical utilization of natural gas. Natural gas is mainly composed of alkanes, among which methane is in a large proportion. Catalytic reforming of methane to prepare syngas mainly includes reforming of methane and steam, partial oxidative reforming of methane, and reforming of methane and carbon dioxide (dry reforming of methane, hereinafter referred to as DRM). DRM could convert both of the two greenhouse gases of methane and carbon dioxide (CO₂), which is conducive to alleviation of the greenhouse effect and atmospheric pollution. CO-rich syngas produced by DRM is suitable for oxo-synthesis and Fischer-Tropsch synthesis to prepare oxygen-containing compounds such as higher aliphatic alcohols, which is conducive to the clean recycling of carbon resources.

Due to high activities and low cost, nickel-based catalysts are considered as promising industrialization systems for DRM. DRM is endothermic, which needs to react at 700° C. or higher to allow a substantial CH₄ and CO₂ conversion. However, the Ni-based catalyst is easily deactivated during the reaction process due to carbon deposition resulting from CH₄ decomposition and/or CO disproportionation and sintering caused by the migration and aggregation of Ni particles at high temperature, resulting in a decline in activity and thus the poor stability of the Ni-based catalyst. Currently, major strategies have been dedicated to improving the issues associated with high resistance to carbon deposition and sintering in DRM, such as constructing metal-support interaction, use of a support structure to confine Ni, removing coke by oxygen vacancies on the support, and adding transition metals or precious metal additive.

In recent years, many in-depth studies have been conducted for how to prepare a nickel-based catalyst with high resistance to carbon deposition and sintering at low and high temperatures. A preparation method of a supported catalyst is relatively simple, and a nickel-based catalyst with an Al-based support usually has a relatively-high initial activity for DRM. However, the Al-based catalyst may be deactivated because of the unstable support structure, which is prone to phase transformation during reaction, and due to reduction of active sites on the surface of the catalyst caused by carbon deposition and sintering. In view of this, the reaction stability of the existing Ni supported Al-based catalysts still needs to be improved.

### SUMMARY

In view of this, the present disclosure aims to provide a nickel-nickel aluminum spinel-calcium hexaaluminate composite catalyst and a preparation method and use thereof. The nickel-nickel aluminum spinel-calcium hexaaluminate composite catalyst according to the present disclosure exhibits high activity and strong resistance to carbon deposition and sintering, and could efficiently catalyze the DRM reaction at high temperature.

To achieve the above objects of the present disclosure, the present disclosure provides the following technical solutions.

The present disclosure provides a method for preparing a nickel-nickel aluminum spinel-calcium hexaaluminate composite catalyst, including the following steps:
mixing a nickel salt metal precursor, an aluminum salt metal precursor, a calcium salt metal precursor, and an organic fuel to obtain a mixed precursor;
drying and calcining the mixed precursor sequentially to obtain a nickel aluminum spinel-calcium hexaaluminate composite precursor; and
placing the nickel aluminum spinel-calcium hexaaluminate composite precursor in a flowing hydrogen atmosphere, and subjecting the nickel aluminum spinel-calcium hexaaluminate composite precursor to reduction reaction to obtain the nickel-nickel aluminum spinel-calcium hexaaluminate composite catalyst.

In some embodiments, the mixing is conducted in a solvent or under milling;
the solvent is one or more selected from the group consisting of water and ethanol; and
the milling is conducted by manual milling or in a ball mill.

In some embodiments, a molar ratio of nickel, aluminum, and calcium in the mixed precursor is in a range of (0.2-0.8):(12.4-13.6):1.

In some embodiments, the organic fuel is one or more selected from the group consisting of alanine, urea, citric acid, maleic hydrazide, and carbohydrazide; and
a ratio of an amount of substance of the organic fuel to a total amount of substance of the nickel salt metal precursor, the aluminum salt metal precursor, and the calcium salt metal precursor is in a range of (1-5):1.

In some embodiments, the drying is conducted at a temperature of 60° C. to 150° C. for 0.5 h to 3 h; and the calcining is conducted at a temperature of 200° C. to 800° C. for 1 h to 12 h.

In some embodiments, a flow rate of hydrogen in the flowing hydrogen atmosphere is in a range of 10 mL/min to 50 mL/min; and
the reduction reaction is conducted at a temperature of 700° C. to 950° C. for 1 h to 5 h.

The present disclosure also provides a nickel-nickel aluminum spinel-calcium hexaaluminate composite catalyst prepared by the method described above, where the nickel-nickel aluminum spinel-calcium hexaaluminate composite catalyst includes phases Ni, NiAl₂O₄, and CaAl₁₂O₁₉. The Ni phase exists in an elemental form, and in some embodiments, Ni particle size is located at 5 nm to 20 nm.

In some embodiments, in the nickel-nickel aluminum spinel-calcium hexaaluminate composite catalyst, a mass of nickel element accounts for 3% to 10% of a total mass of nickel, aluminum, and calcium elements.

The present disclosure also provides use of the nickel-nickel aluminum spinel-calcium hexaaluminate composite catalyst described above in DRM.

The present disclosure also provides a method for DRM, including the following steps:
continuously feeding CH₄ and CO₂ into a reactor containing the nickel-nickel aluminum spinel-calcium hexaaluminate composite catalyst described above, and conducting the DRM to obtain CO and H₂ as product gases.

The present disclosure provides a method for preparing a nickel-nickel aluminum spinel-calcium hexaaluminate composite catalyst, including the following steps: mixing a nickel salt metal precursor, an aluminum salt metal precursor, a calcium salt metal precursor, and an organic fuel to obtain a mixed precursor; drying and calcining the mixed precursor sequentially to obtain a nickel aluminum spinel-calcium hexaaluminate composite precursor; and placing the nickel aluminum spinel-calcium hexaaluminate composite precursor in a flowing hydrogen atmosphere and subjecting the nickel aluminum spinel-calcium hexaaluminate composite precursor to a reduction reaction in the flowing hydrogen atmosphere to obtain the nickel-nickel aluminum spinel-calcium hexaaluminate composite catalyst. In the present disclosure, the nickel-nickel aluminum spinel-calcium hexaaluminate composite catalyst is prepared with calcination-reduction method by mixing metal salts and an organic fuel. The composite catalyst has a stable layered microstructure, and Ni could be effectively controlled in a sub-surface layer of the composite catalyst, so that the strong interaction between Ni and the nickel aluminum spinel-calcium hexaaluminate composite support is produced, effectively inhibiting the migration and sintering of Ni under high-temperature conditions. Moreover, the presence of the nickel-nickel aluminum spinel-calcium hexaaluminate composite structure in the catalyst could effectively inhibit the generation of carbon deposition, well playing a catalytic role. The nickel-nickel aluminum spinel-calcium hexaaluminate composite catalyst according to the present disclosure exhibits strong thermal stability and chemical stability during DRM reaction at high temperature, and could stably perform for 1,000 h or more. Thus, the catalyst presents a long operation life during DRM at high temperature, effectively inhibiting the sintering of nickel and the carbon deposition of the catalyst, and exhibits a relatively-high activity and stability. Results of the examples show that the nickel-nickel aluminum spinel-calcium hexaaluminate composite catalyst according to the present disclosure exhibits a high catalytic activity and stability at 800° C., and has a CH₄ conversion of 88.3% to 95.2% and a CO₂ conversion of 82.8% to 93.1% within 50 h.

In addition, the preparation method according to the present disclosure is relatively simple and rapid, and raw materials involved in the preparation method are easily available and cheap, which facilitates the industrial batch production.

### BRIEF DESCRIPTION OF THE DRAWINGS

FIG. 1 shows X-ray diffraction (XRD) patterns of nickel aluminum spinel-calcium hexaaluminate composite precursors with different nickel contents.

FIG. 2 shows a high-resolution transmission electron microscopy (HRTEM) image of the nickel-nickel aluminum spinel-calcium hexaaluminate composite catalyst prepared in Example 1.

FIG. 3 shows an HRTEM image of the nickel-nickel aluminum spinel-alumina composite catalyst prepared in Comparative Example 1.

FIG. 4 shows test results of stability in catalytic performance of the catalyst prepared in Example 2 for DRM at 800° C.

FIG. 5 shows test results of stability in catalytic performance of the catalyst prepared in Example 3 for DRM at 800° C.

FIG. 6 is a thermogravimetric analysis (TGA) curve of the catalyst prepared in Example 3 after 300 h stability evaluation.

FIG. 7 shows an XRD pattern of the catalyst prepared in Comparative Example 3 after calcining.

### DETAILED DESCRIPTION OF THE EMBODIMENTS

The present disclosure provides a method for preparing a nickel-nickel aluminum spinel-calcium hexaaluminate composite catalyst, including (or consisting of) the following steps:
mixing a nickel salt metal precursor, an aluminum salt metal precursor, a calcium salt metal precursor, and an organic fuel to obtain a mixed precursor;
drying and calcining the mixed precursor sequentially to obtain a nickel aluminum spinel-calcium hexaaluminate composite precursor; and
placing the nickel aluminum spinel-calcium hexaaluminate composite precursor in a flowing hydrogen atmosphere, and subjecting the nickel aluminum spinel-calcium hexaaluminate composite precursor to reduction reaction to obtain the nickel-nickel aluminum spinel-calcium hexaaluminate composite catalyst.

Unless otherwise specified, the raw materials used herein are all commercially available.

In some embodiments, a nickel salt metal precursor, an aluminum salt metal precursor, a calcium salt metal precursor, and an organic fuel are mixed to obtain a mixed precursor. In some embodiments, the nickel salt metal precursor is one or more selected from the group consisting of nickel chloride, nickel nitrate, and nickel sulfate; the aluminum salt metal precursor is one or more selected from the group consisting of aluminum isopropoxide, aluminum nitrate, aluminum chloride, and aluminum sulfate; and the calcium salt metal precursor is one or more selected from the group consisting of calcium nitrate, calcium chloride, and calcium sulfate.

In some embodiments, in the nickel salt metal precursor, the aluminum salt metal precursor, and the calcium salt metal precursor, a molar ratio of nickel, aluminum, and calcium elements is in a range of x:(12+2x):1, where x is in a range of 0.2 to 0.8 and preferably 0.4 to 0.6, that is, a molar ratio of nickel, aluminum, and calcium element is in a range of (0.2-0.8):(12.4-13.6):1, and preferably (0.4-0.6):(12.8-13.2):1.

In some embodiments, the organic fuel is one or more selected from the group consisting of alanine, urea, citric acid, maleic hydrazide, and carbohydrazide; and a ratio of an amount of substance of the organic fuel to a total amount of substance of the nickel salt metal precursor, the aluminum salt metal precursor, and the calcium salt metal precursor is in a range of (1-5):1, and preferably (2-4):1. In the present disclosure, the organic fuel allows uniform mixing of the organic fuel and the metal precursors at a molecular level, and a combustion reaction spreads automatically and occurs inside the metal precursors during a combustion process, which promotes the phase transformation to obtain target oxides.

In some embodiments, the mixing is conducted in a solvent or under milling. Under the condition that the mixing is conducted in a solvent, in some embodiments, the mixing is conducted as follows: the nickel salt metal precursor, the aluminum salt metal precursor, the calcium salt metal precursor, and the organic fuel are mixed with the solvent; in some embodiments, the solvent is one or two selected from the group consisting of water and ethanol, and the water is deionized water and the ethanol is absolute ethanol; and in some embodiments, the mixing in the solvent is conducted for 30 min to 2 h, and preferably 1 h to 1.5 h.

Under the condition that the mixing is conducted under milling, the milling is conducted by manual milling or in a ball mill. In some embodiments, the manual milling is conducted for 30 min to 60 min. In some embodiments, the milling is conducted in a ball mill at a rotational speed of 500 rpm to 2,000 rpm for 1 h to 3 h.

After the mixed precursor is obtained, the mixed precursor is dried and calcined sequentially to obtain a nickel aluminum spinel-calcium hexaaluminate composite precursor. In some embodiments, the drying is conducted in an oven. In some embodiments, the drying is conducted at a temperature of 60° C. to 150° C., and preferably 80° C. to 120° C.; and the drying is conducted for 0.5 h to 3 h, and preferably 1 h to 2 h.

In some embodiments, a dried product is placed in a crucible, then transferred in a preheated muffle furnace and subjected to calcining. In some embodiments, the calcining is conducted in an air atmosphere.

In some embodiments, the calcining is conducted at a temperature of 200° C. to 800° C. and preferably 500° C. to 600° C.; and the calcining is conducted for 1 h to 12 h, preferably 3 h to 10 h, and more preferably 5 h to 8 h. In the present disclosure, during the calcining, the metal is converted into metal oxide; and the nitrate is converted into NO₂, the chloride ion is converted into Cl₂, and the sulfate is converted into SO₂, so that the nitrate, the chloride ion, and the sulfate are removed from the precursor.

After the nickel aluminum spinel-calcium hexaaluminate composite precursor is obtained, it is placed in a flowing hydrogen atmosphere and subjected to reduction reaction to obtain the nickel-nickel aluminum spinel-calcium hexaaluminate composite catalyst. In some embodiments, a flow rate of hydrogen in the flowing hydrogen atmosphere is in a range of 10 mL/min to 50 mL/min and preferably 20 mL/min to 40 mL/min; and the reduction reaction is conducted at a temperature of 700° C. to 950° C. and preferably 800° C. to 900° C., and the reduction reaction is conducted for 1 h to 5 h and preferably 2 h to 4 h. In the present disclosure, during the reduction reaction, Ni particles are gradually produced from a nickel aluminum spinel in the nickel aluminum spinel-calcium hexaaluminate composite precursor through hydrogen reduction.

The present disclosure also provides a nickel-nickel aluminum spinel-calcium hexaaluminate composite catalyst prepared by the method described above, where the nickel-nickel aluminum spinel-calcium hexaaluminate composite catalyst includes phases Ni, NiAl₂O₄, and CaAl₁₂O₁₉.

In some embodiments, Ni exists in an elemental particle form, and Ni particle size is located at 5 nm to 20 nm.

In some embodiments, in the nickel-nickel aluminum spinel-calcium hexaaluminate composite catalyst, a mass of nickel element accounts for 3% to 10% and preferably 5% to 8% of a total mass of nickel, aluminum, and calcium elements, that is, Ni/(Ni+Al+Ca) is in a range of 3% to 10% and preferably 5% to 8%. The nickel-nickel aluminum spinel-calcium hexaaluminate composite catalyst according to the present disclosure has a stable layered microstructure, which could effectively control nickel in a sub-surface layer of the catalyst.

The present disclosure also provides use of the nickel-nickel aluminum spinel-calcium hexaaluminate composite catalyst described above in DRM reaction.

The present disclosure also provides a method for DRM, including the following steps:
continuously feeding CH₄ and CO₂ into a reactor containing a nickel-nickel aluminum spinel-calcium hexaaluminate composite catalyst, and conducting DRM to obtain CO and H₂ as product gases.

In some embodiments, a volume ratio of CH₄ to CO₂ is 1:1; a space velocity of CH₄ and CO₂ is in a range of 15,000 h⁻¹ to 60,000 h⁻¹ and preferably 25,000 h⁻¹ to 40,000 h⁻¹; and DRM is conducted at a temperature of 750° C. to 850° C. and preferably 800° C.

The nickel-nickel aluminum spinel-calcium hexaaluminate composite catalyst and the preparation method and use thereof will be described in detail below with reference to examples, but these examples should not be construed as limiting the scope of the present disclosure.

### Example 1

A method for preparing a nickel-nickel aluminum spinel-calcium hexaaluminate composite catalyst was performed as follows.

(1) 0.116 g of nickel nitrate, 5.067 g of aluminum isopropoxide, 0.472 g of calcium nitrate, and 1.632 g of urea were dissolved in 20 mL of deionized water, and a resulting solution was stirred for 30 min to obtain a metal salt-urea mixed precursor.

(2) The metal salt-urea mixed precursor was dried in an oven at 120° C. for 3 h to obtain a dried mixed precursor.

(3) The dried mixed precursor was transferred to a crucible, then transferred in a muffle furnace preheated to 700° C., and then subjected to calcining for 2 h to obtain a nickel aluminum spinel-calcium hexaaluminate composite precursor with Ni/(Ni+Al+Ca) of 3 wt %.

(4) The nickel aluminum spinel-calcium hexaaluminate composite precursor was reduced in hydrogen with a flow rate of 20 mL/min for 1 h at 900° C. to obtain the nickel-nickel aluminum spinel-calcium hexaaluminate composite catalyst with Ni/(Ni+Al+Ca) of 3 wt %.

### Example 2

A method for preparing a nickel-nickel aluminum spinel-calcium hexaaluminate composite catalyst was performed as follows.

(1) 0.421 g of nickel sulfate, 10.204 g of aluminum nitrate, 0.472 g of calcium nitrate, and 29.585 g of citric acid were dissolved in 20 mL of absolute ethanol, and a resulting solution was stirred for 1 h to obtain a metal salt-citric acid mixed precursor.

(2) The metal salt-citric acid mixed precursor was dried in an oven at 60° C. for 0.5 h to obtain a dried mixed precursor.

(3) The dried mixed precursor was transferred to a crucible, then transferred in a muffle furnace preheated to 500° C., and then subjected to calcining for 6 h to obtain a nickel aluminum spinel-calcium hexaaluminate composite precursor with Ni/(Ni+Al+Ca) of 10 wt %.

(4) The nickel aluminum spinel-calcium hexaaluminate composite precursor was reduced in hydrogen with a flow rate of 10 mL/min for 2 h at 950° C. to obtain the nickel-nickel aluminum spinel-calcium hexaaluminate composite catalyst with Ni/(Ni+Al+Ca) of 10 wt %.

### Example 3

A method for preparing a nickel-nickel aluminum spinel-calcium hexaaluminate composite catalyst was performed as follows.

(1) 0.201 g of nickel chloride, 6.201 g of aluminum chloride, 0.438 g of calcium chloride, 5.084 g of alanine, and 5.135 g of urea were mixed for 1 h in a ball mill at a rotational speed of 2,000 rpm to obtain a metal salt-alanine-urea mixed precursor.

(2) The metal salt-alanine-urea mixed precursor was dried in an oven at 150° C. for 2 h to obtain a dried mixed precursor.

(3) The dried mixed precursor was transferred to a crucible, then transferred in a muffle furnace preheated to 200° C., and then subjected to calcining for 12 h to obtain a nickel aluminum spinel-calcium hexaaluminate composite precursor with Ni/(Ni+Al+Ca) of 6 wt %.

(4) The nickel aluminum spinel-calcium hexaaluminate composite precursor was reduced in hydrogen with a flow rate of 50 mL/min for 5 h at 700° C. to obtain the nickel-nickel aluminum spinel-calcium hexaaluminate composite catalyst with Ni/(Ni+Al+Ca) of 6 wt %.

### Example 4

A method for a nickel-nickel aluminum spinel-calcium hexaaluminate composite catalyst was performed as follows.

(1) 0.341 g of nickel nitrate, 9.648 g of aluminum sulfate, 0.472 g of calcium nitrate, and 7.976 g of carbohydrazide were dissolved in 20 mL of deionized water, and a resulting solution was stirred for 1.5 h to obtain a metal salt-carbohydrazide mixed precursor.

(2) The metal salt-carbohydrazide mixed precursor was dried in an oven at 100° C. for 3 h to obtain a dried mixed precursor.

(3) The dried mixed precursor was transferred to a crucible, then transferred in a muffle furnace preheated to 800° C., and then subjected to calcining for 1 h to obtain a nickel aluminum spinel-calcium hexaaluminate composite precursor with Ni/(Ni+Al+Ca) of 8 wt %.

(4) The nickel aluminum spinel-calcium hexaaluminate composite precursor was reduced in hydrogen with a flow rate of 40 mL/min for 3 h at 800° C. to obtain the nickel-nickel aluminum spinel-calcium hexaaluminate composite catalyst with Ni/(Ni+Al+Ca) of 8 wt %.

### Example 5

A method for preparing a nickel-nickel aluminum spinel-calcium hexaaluminate composite catalyst was performed as follows.

(1) 0.199 g of nickel nitrate, 5.246 g of aluminum isopropoxide, 0.258 g of calcium chloride, and 8.56 g of urea were manually milled in a mortar for 1 h.

(2) The metal salt-urea mixed precursor was dried in an oven at 130° C. for 1 h to obtain a dried mixed precursor.

(3) The dried mixed precursor was transferred to a crucible, then transferred in a muffle furnace preheated to 600° C., and then subjected to calcining for 4 h to obtain a nickel aluminum spinel-calcium hexaaluminate composite precursor with Ni/(Ni+Al+Ca) of 6 wt %.

(4) The nickel aluminum spinel-calcium hexaaluminate composite precursor was reduced in hydrogen with a flow rate of 30 mL/min for 4 h at 750° C. to obtain the nickel-nickel aluminum spinel-calcium hexaaluminate composite catalyst with Ni/(Ni+Al+Ca) of 6 wt %.

### Example 6

A method for preparing a nickel-nickel aluminum spinel-calcium hexaaluminate composite catalyst was performed as follows.

(1) 0.616 g of nickel sulfate, 19.296 g of aluminum sulfate, 0.876 g of calcium chloride, and 13.71 g of maleic hydrazide were dissolved in 20 mL of deionized water, and a resulting solution was stirred for 1 h to obtain a metal salt-maleic hydrazide mixed precursor.

(2) The metal salt-maleic hydrazide mixed precursor was dried in an oven at 120° C. for 3 h to obtain a dried mixed precursor.

(3) The dried mixed precursor was transferred to a crucible, then transferred in a muffle furnace preheated to 800° C., and then subjected to calcining for 10 h to obtain a nickel aluminum spinel-calcium hexaaluminate composite precursor with Ni/(Ni+Al+Ca) of 8 wt %.

(4) The nickel aluminum spinel-calcium hexaaluminate composite precursor was reduced in hydrogen with a flow rate of 40 mL/min for 1 h at 850° C. to obtain the nickel-nickel aluminum spinel-calcium hexaaluminate composite catalyst with Ni/(Ni+Al+Ca) of 8 wt %.

### Example 7

(1) 0.160 g of nickel nitrate, 9.192 g of aluminum nitrate, 0.472 g of calcium nitrate, and 15.938 g of citric acid were manually milled for 30 min to obtain a metal salt-citric acid mixed precursor.

(2) The metal salt-citric acid mixed precursor was dried in an oven at 100° C. for 2 h to obtain a dried mixed precursor.

(3) The dried mixed precursor was transferred to a crucible, then transferred in a muffle furnace preheated to 500° C., and then subjected to calcining for 8 h to obtain a nickel aluminum spinel-calcium hexaaluminate composite precursor with Ni/(Ni+Al+Ca) of 4 wt %.

(4) The nickel aluminum spinel-calcium hexaaluminate composite precursor was reduced in hydrogen with a flow rate of 20 mL/min for 1.5 h at 900° C. to obtain the nickel-nickel aluminum spinel-calcium hexaaluminate composite catalyst with Ni/(Ni+Al+Ca) of 4 wt %.

### Example 8

(1) 0.181 g of nickel nitrate, 9.519 g of aluminum nitrate, 0.472 g of calcium nitrate, and 3.368 g of urea were stirred for 3 h in a ball mill at a rotational speed of 500 rpm to obtain a metal salt-urea mixed precursor.

(2) The metal salt-urea mixed precursor was dried in an oven at 130° C. for 1.5 h to obtain a mixed precursor.

(3) The mixed precursor was transferred to a crucible, then transferred in a muffle furnace preheated to 300° C., and subjected to calcining for 8 h to obtain a nickel aluminum spinel-calcium hexaaluminate composite precursor with Ni/(Ni+Al+Ca) of 5 wt %.

(4) The nickel aluminum spinel-calcium hexaaluminate composite precursor was reduced in hydrogen with a flow rate of 25 mL/min for 2 h at 900° C. to obtain the nickel-nickel aluminum spinel-calcium hexaaluminate composite catalyst with Ni/(Ni+Al+Ca) of 5 wt %.

### Comparative Example 1

A method for preparing a nickel-nickel aluminum spinel-alumina composite catalyst was performed similar to Example 1 except that the following:

(1) 0.085 g of nickel nitrate, 5.049 g of aluminum isopropoxide, and 1.473 g of urea were dissolved in 20 mL of deionized water, and a resulting solution was stirred for 30 min to obtain a metal salt-urea mixed precursor.

(2) The metal salt-urea mixed precursor was dried in an oven at 120° C. for 3 h to obtain a dried mixed precursor.

(3) The dried mixed precursor was transferred to a crucible, then transferred in a muffle furnace preheated to 700° C., and subjected to calcining for 2 h to obtain a nickel aluminum spinel-alumina composite precursor with Ni/(Ni+Al) of 3 wt %.

(4) The nickel aluminum spinel-alumina composite precursor was reduced in hydrogen with a flow rate of 20 mL/min for 1 h at 900° C. to obtain the nickel-nickel aluminum spinel-alumina composite catalyst with Ni/(Ni+Al) of 3 wt %.

### Comparative Example 2

A method for preparing a nickel-nickel aluminum spinel-alumina composite catalyst was performed similar to Example 2 except that the following:

(1) 0.378 g of nickel sulfate, 10.253 g of aluminum nitrate, and 28.285 g of citric acid were dissolved in 20 mL of absolute ethanol, and a resulting solution was stirred for 1 h to obtain a metal salt-citric acid mixed precursor.

(2) The metal salt-citric acid mixed precursor was dried in an oven at 60° C. for 0.5 h to obtain a dried mixed precursor.

(3) The dried mixed precursor was transferred to a crucible, then transferred in a muffle furnace preheated to 500° C., and then subjected to calcining for 6 h to obtain a nickel aluminum spinel-alumina composite precursor with Ni/(Ni+Al) of 10 wt %.

(4) The nickel aluminum spinel-alumina composite precursor was reduced in hydrogen with a flow rate of 10 mL/min for 2 h at 950° C. to obtain the nickel-nickel aluminum spinel-alumina composite catalyst with Ni/(Ni+Al) of 10 wt %.

### Comparative Example 3

A method for preparing a nickel-nickel aluminum spinel-calcium hexaaluminate composite catalyst was performed as follows:

(1) 0.116 g of nickel nitrate, 5.067 g of aluminum isopropoxide, 0.472 g of calcium nitrate, and 1.632 g of urea were dissolved in 20 mL of deionized water, and a resulting solution was stirred for 30 min to obtain a metal salt-urea mixed precursor.

(2) The metal salt-urea mixed precursor was dried in an oven at 60° C. for 3 h to obtain a dried mixed precursor.

(3) The dried mixed precursor was transferred to a crucible, then transferred in a muffle furnace preheated to 150° C., and then subjected to calcining for 12 h to obtain a nickel aluminum spinel-calcium hexaaluminate composite precursor with Ni/(Ni+Al+Ca) of 3 wt %.

(4) The nickel aluminum spinel-calcium hexaaluminate composite precursor was reduced in hydrogen with a flow rate of 20 mL/min for 1 h at 900° C. to obtain the nickel-nickel aluminum spinel-calcium hexaaluminate composite catalyst with Ni/(Ni+Al+Ca) of 3 wt %.

### Structural Characterization

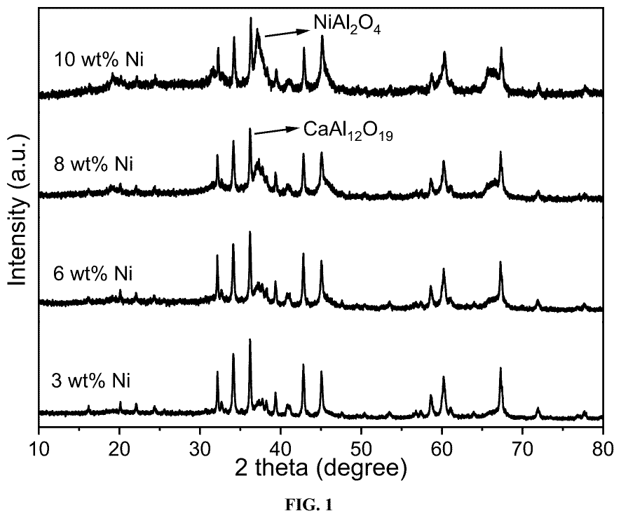

XRD patterns of nickel aluminum spinel-calcium hexaaluminate composite precursors with different nickel contents are shown in FIG. 1. It can be seen from FIG. 1 that the nickel aluminum spinel-calcium hexaaluminate composite precursors with different nickel contents each are composed of the two phases of NiAl₂O₄ and CaAl₁₂O₁₉.

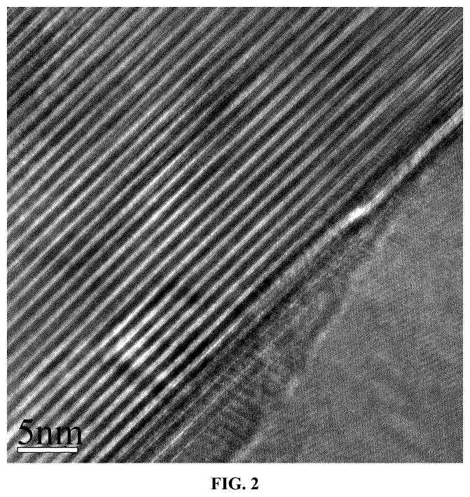

An HRTEM image of the nickel-nickel aluminum spinel-calcium hexaaluminate composite catalyst prepared in Example 1 is shown in FIG. 2. It can be seen from FIG. 2 that the nickel-nickel aluminum spinel-calcium hexaaluminate composite catalyst has a layered structure in which nickel species are well dispersed.

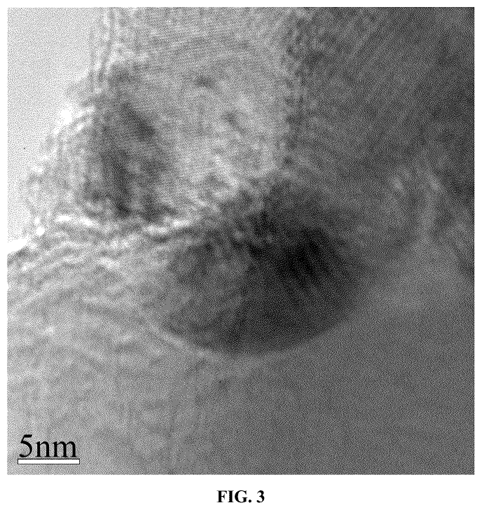

An HRTEM image of the nickel-nickel aluminum spinel-alumina composite catalyst prepared in Comparative Example 1 is shown in FIG. 3. It can be seen from FIG. 3 that the nickel-nickel aluminum spinel-alumina composite catalyst does not have a layered structure.

### Use Example 1

The catalytic performance of each of the nickel-nickel aluminum spinel-calcium hexaaluminate composite catalysts prepared in Examples 1 and 2 and the nickel-nickel aluminum spinel-alumina composite catalysts prepared in Comparative Examples 1 to 2 for DRM was tested, and specific experimental operations were as follows.

0.1 g of a catalyst was diluted with 0.35 g of a quartz sand, then loaded into a fixed-bed quartz tube reactor, and heated to 800° C. in a N2 atmosphere; after that, CH₄ and CO₂ were introduced thereto at a molar ratio of 1:1, and then subjected to reaction; and a product was analyzed on-line. Stability test results of the catalysts are shown in Tables 1 and 2.

TABLE 1
Stability test results of the catalysts prepared
in Example 1 and Comparative Example 1

| | Reaction | | | | | |
|---|---|---|---|---|---|---|
| | Tempera- | Space | | | | |
| | ture | velocity | | Reaction time | | |
| Catalyst | (° C.) | (h⁻¹) | | 10 h | 30 h | 50 h |
| Example 1 | 800 | 30,000 | CH₄ conversion, | 88.8 | 88.5 | 88.3 |
| | | | (%) | | | |
| | | | CO₂ conversion, | 87.8 | 88.2 | 88.5 |
| | | | (%) | | | |
| | | | H₂/CO | 0.90 | 0.91 | 0.91 |
| Compara- | 800 | 30,000 | CH₄ conversion, | 88.4 | 75.2 | 72.2 |
| tive | | | (%) | | | |
| Example 1 | | | CO₂ conversion, | 88.2 | 72.7 | 69.7 |
| | | | (%) | | | |
| | | | H₂/CO | 0.90 | 0.85 | 0.83 |

TABLE 2
Stability test results of the catalysts prepared
in Example 2 and Comparative Example 2

| | Reaction | | | | | |
|---|---|---|---|---|---|---|
| | Tempera- | Space | | | | |
| | ture | velocity | | Reaction time | | |
| Catalyst | (° C.) | (h⁻¹) | | 10 h | 30 h | 50 h |
| Example 2 | 800 | 30000 | CH₄ conversion, | 95.1 | 95.2 | 95.2 |
| | | | (%) | | | |
| | | | CO₂ conversion, | 92.3 | 92.4 | 92.7 |
| | | | (%) | | | |
| | | | H₂/CO | 0.93 | 0.93 | 0.93 |
| Compara- | 800 | 30000 | CH₄ conversion, | 93.3 | 89.4 | 88.7 |
| tive | | | (%) | | | |
| Example 2 | | | CO₂ conversion, | 91.4 | 88.7 | 88.3 |
| | | | % | | | |
| | | | H₂/CO | 0.91 | 0.91 | 0.91 |

It can be seen from Table 1 that, when the catalysts with the same nickel content prepared in Example 1 and Comparative Example 1 are used for DRM at high temperature, conversions of CH₄ and CO₂ for the catalyst prepared in Comparative Example 1 decrease continuously, while the catalyst prepared in Example 1 could stably and efficiently catalyze DRM at the high temperature with a stable conversion of CH₄ and CO₂.

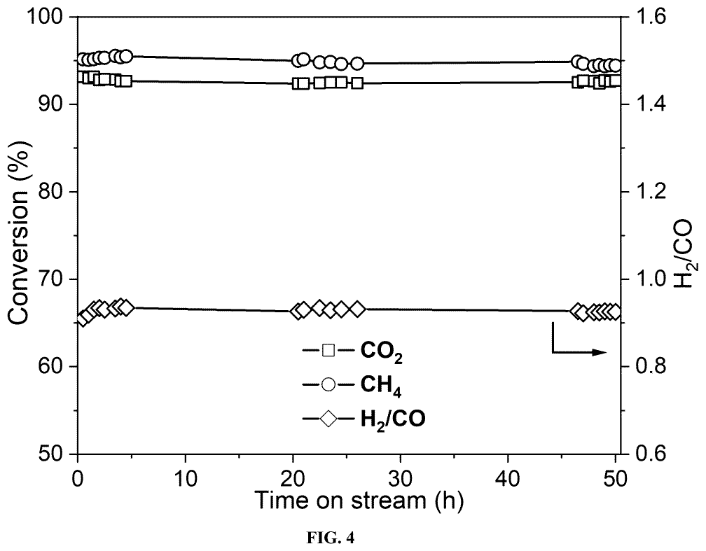

Test results of stability of catalytic performance of the catalyst prepared in Example 2 for DRM at 800° C. are shown in FIG. 4. It can be seen from Table 2 and FIG. 4 that a nickel-nickel aluminum spinel-calcium hexaaluminate composite catalyst with Ni/(Ni+Ca+Al) of 10 wt % could still maintain a stable reactant conversion, and in contrast, the conversion of the catalyst with a nickel content of 10 wt % prepared in Comparative Example 2 continuously decreases during 50 h operation life evaluation.

### Use Example 2

The nickel-nickel aluminum spinel-calcium hexaaluminate composite catalysts (Examples 3 to 6) with Ni/(Ni+Ca+Al) of 6 wt % and 8 wt % each were subjected to stability evaluation at 800° C., a space velocity of 30,000 h⁻¹, and a ratio of CH₄ to CO₂ of 1:1. Evaluation results are shown in Table 3.

TABLE 3
Stability test results of the catalysts prepared in Examples 3 to 6

| | Reaction | | | | | |
|---|---|---|---|---|---|---|
| | Tempera- | Space | | | | |
| | ture | velocity | | Reaction time | | |
| Catalyst | (° C.) | (h⁻¹) | | 10 h | 30 h | 50 h |
| Example 3 | 800 | 30,000 | CH₄ conversion, | 92.9 | 93.6 | 93.7 |
| | | | (%) | | | |
| | | | CO₂ conversion, | 92.4 | 92.7 | 92.9 |
| | | | (%) | | | |
| | | | H₂/CO | 0.91 | 0.92 | 0.92 |
| Example 4 | 800 | 30,000 | CH₄ conversion, | 93.7 | 93.9 | 94.1 |
| | | | (%) | | | |
| | | | CO₂ conversion, | 92.5 | 92.7 | 82.8 |
| | | | (%) | | | |
| | | | H₂/CO | 0.91 | 0.91 | 0.91 |
| Example 5 | 800 | 30,000 | CH₄ conversion, | 92.3 | 92.6 | 92.9 |
| | | | (%) | | | |
| | | | CO₂ conversion, | 92.2 | 92.4 | 92.8 |
| | | | (%) | | | |
| | | | H₂/CO | 0.91 | 0.91 | 0.92 |
| Example 6 | 800 | 30,000 | CH₄ conversion, | 94.4 | 95.1 | 95.2 |
| | | | (%) | | | |
| | | | CO₂ conversion, | 92.6 | 92.7 | 93.1 |
| | | | (%) | | | |
| | | | H₂/CO | 0.92 | 0.92 | 0.93 |

It can be seen from Table 3 that the conversions of CH₄ and CO₂ and the H₂/CO ratio remain stable during the 50 h stability test.

### Use Example 3

The catalyst prepared in Example 3 was subjected to long-term stability evaluation at 800° C., a space velocity of 30,000 h⁻¹, and a CH₄/CO₂ ratio of 1:1.

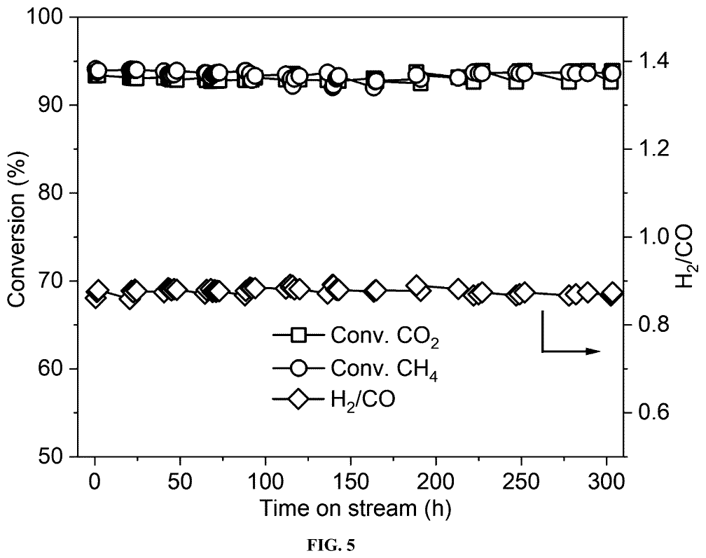

Test results of stability of catalytic performance of the catalyst prepared in Example 3 for DRM at 800° C. are shown in FIG. 5, and it can be seen that the catalyst prepared in Example 3 maintains CH₄ conversion of 93% or more and CO₂ conversion of about 92% within 300 h.

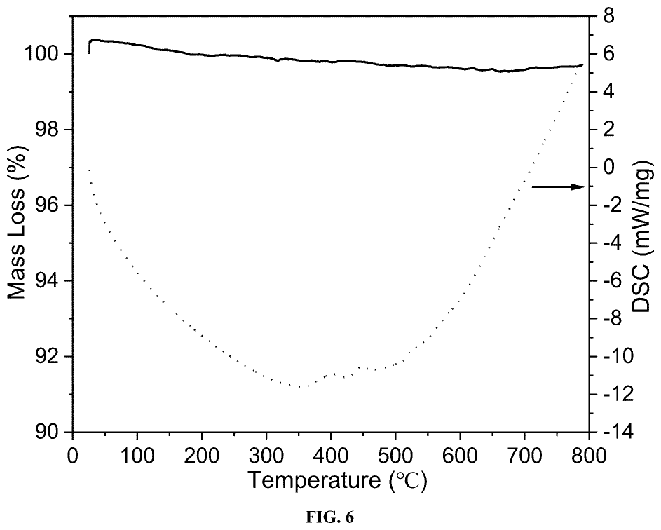

FIG. 6 shows a TGA curve of the catalyst prepared in Example 3 after 300 h stability evaluation, and it can be seen that the catalyst prepared in Example 3 has very low carbon deposition, indicating that the nickel-nickel aluminum spinel-calcium hexaaluminate composite catalyst prepared by the preparation method according to the present disclosure has an excellent carbon deposition resistance and high temperature stability.

### Use Example 4

The catalysts prepared in Examples 7 and 8 each were subjected to stability evaluation at 800° C., a space velocity of 15,000 h⁻¹ to 60,000 h⁻¹, and a CH₄/CO₂ ratio of 1:1. Evaluation results are shown in Table 4. It can be seen from the evaluation results that conversions at different space velocities are slightly different, but remain stable within 50 h.

TABLE 4
Test results of the catalysts prepared in Examples
7 and 8 at different space velocities

| | Reaction | | | | | |
|---|---|---|---|---|---|---|
| | Tempera- | Space | | | | |
| | ture | velocity | | Reaction time | | |
| Catalyst | (° C.) | (h⁻¹) | | 10 h | 30 h | 50 h |
| Example 7 | 800 | 15,000 | CH₄ conversion, | 93.3 | 94.4 | 94.5 |
| | | | (%) | | | |
| | | | CO₂ conversion, | 93.1 | 94.3 | 94.3 |
| | | | (%) | | | |
| | | | H₂/CO | 0.92 | 0.93 | 0.93 |
| | | 30,000 | CH₄ conversion, | 92.8 | 92.9 | 93.1 |
| | | | (%) | | | |
| | | | CO₂ conversion, | 92.4 | 92.5 | 92.7 |
| | | | (%) | | | |
| | | | H₂/CO | 0.92 | 0.92 | 0.92 |
| | | 60,000 | CH₄ conversion, | 90.6 | 91.0 | 90.8 |
| | | | (%) | | | |
| | | | CO₂ conversion, | 90.4 | 90.3 | 90.6 |
| | | | (%) | | | |
| | | | H₂/CO | 0.92 | 0.92 | 0.92 |
| Example 8 | 800 | 15,000 | CH₄ conversion, | 93.7 | 93.9 | 94.1 |
| | | | (%) | | | |
| | | | CO₂ conversion, | 92.5 | 92.8 | 92.9 |
| | | | (%) | | | |
| | | | H₂/CO | 0.92 | 0.92 | 0.92 |
| | | 30,000 | CH₄ conversion, | 92.9 | 93.2 | 93.9 |
| | | | (%) | | | |
| | | | CO₂ conversion, | 92.9 | 92.9 | 93.7 |
| | | | (%) | | | |
| | | | H₂/CO | 0.92 | 0.92 | 0.92 |
| | | 60,000 | CH₄ conversion, | 90.9 | 91.0 | 91.0 |
| | | | % | | | |
| | | | CO₂ conversion, | 89.9 | 89.9 | 90.0 |
| | | | (%) | | | |
| | | | H₂/CO | 0.90 | 0.90 | 0.91 |

### Use Example 5

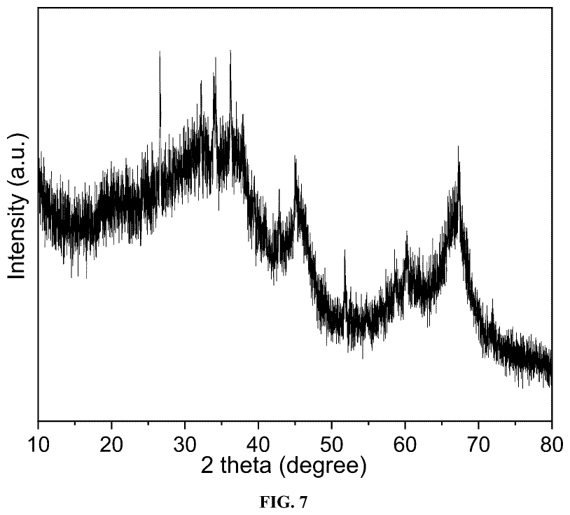

An XRD pattern of the catalyst prepared in Comparative Example 3 after calcining is shown in FIG. 7, and it can be seen that a nickel-nickel aluminum spinel-calcium hexaaluminate phase cannot be prepared at a temperature lower than a specified calcining temperature.

The catalyst prepared in Comparative Example 3 was subjected to stability evaluation at 800° C., a space velocity of 30,000 h⁻¹, and a CH₄/CO₂ ratio of 1:1. Evaluation results are shown in Table 5. It can be seen that the catalyst prepared in Comparative Example 3 has a significantly lower activity than the catalyst with the same nickel content prepared in Example 1, and cannot remain stable within 50 h, indicating that the generation of a nickel-nickel aluminum spinel-calcium hexaaluminate phase is crucial for improvement of reactive activity and stability.

TABLE 5
Stability test results of the catalyst
prepared in Comparative Example 3

| | Reaction | | | | | |
|---|---|---|---|---|---|---|
| | Tempera- | Space | | | | |
| | ture | velocity | | Reaction time | | |
| Catalyst | (° C.) | (h⁻¹) | | 10 h | 30 h | 50 h |
| Compara- | 800 | 30,000 | CH₄ conversion, | 34.1 | 29.6 | 26.0 |
| tive | | | (%) | | | |
| Example 3 | | | CO₂ conversion, | 35.6 | 30.9 | 27.7 |
| | | | (%) | | | |
| | | | H₂/CO | 0.59 | 0.58 | 0.56 |

### Use Example 6

The catalyst prepared in Example 3 was used for a reaction at 750° C. and 850° C., a space velocity of 30,000 h⁻¹, and a CH₄/CO₂ ratio of 1:1. Evaluation results are shown in Table 6. It can be seen that the higher the temperature is, the higher the conversion of the reactant is, and the activity of the catalyst prepared in Example 3 could maintain stable at both 750° C. and 850° C. within 50 h.

TABLE 6
Test results of the catalyst prepared
in Example 3 at different temperatures

| | Reaction | | | | | |
|---|---|---|---|---|---|---|
| | Tempera- | Space | | | | |
| | ture | velocity | | Reaction time | | |
| Catalyst | (° C.) | (h⁻¹) | | 10 h | 30 h | 50 h |
| Example 3 | 750 | 30,000 | CH₄ conversion, | 87.2 | 87.6 | 87.8 |
| | | | (%) | | | |
| | | | CO₂ conversion, | 88.2 | 88.3 | 88.7 |
| | | | (%) | | | |
| | | | H₂/CO | 0.90 | 0.90 | 0.90 |
| | 850 | | CH₄ conversion, | 93.4 | 93.5 | 93.8 |
| | | | (%) | | | |
| | | | CO₂ conversion, | 92.4 | 92.6 | 92.7 |
| | | | (%) | | | |
| | | | H₂/CO | 0.92 | 0.92 | 0.92 |

In summary, the preparation method according to the present disclosure has characteristics such as simplicity, low production cost, and environmental friendliness, and the nickel-nickel aluminum spinel-calcium hexaaluminate composite catalyst prepared by the preparation method exhibits high sintering and carbon deposition resistance during high-temperature DRM reaction, greatly improving the stability of the catalyst.

The above are merely preferred embodiments of the present disclosure. It should be noted that a person of ordinary skill in the art may further make several improvements and modifications without departing from the principle of the present disclosure, and such improvements and modifications should be deemed as falling within the scope of the present disclosure.

What is claimed is:

1. A method for preparing a nickel-nickel aluminum spinel-calcium hexaaluminate composite catalyst, comprising the following steps:
mixing a nickel salt metal precursor, an aluminum salt metal precursor, a calcium salt metal precursor, and an organic fuel to obtain a mixed precursor;
drying and calcining the mixed precursor sequentially to obtain a nickel aluminum spinel-calcium hexaaluminate composite precursor; and
placing the nickel aluminum spinel-calcium hexaaluminate composite precursor in a flowing hydrogen atmosphere, and subjecting the nickel aluminum spinel-calcium hexaaluminate composite precursor to reduction reaction to obtain the nickel-nickel aluminum spinel-calcium hexaaluminate composite catalyst.

2. The method according to claim 1, wherein the mixing is conducted in a solvent or under milling;
the solvent is one or more selected from the group consisting of water and ethanol; and
the milling is conducted by manual milling or in a ball mill.

3. The method according to claim 1, wherein a molar ratio of nickel, aluminum, and calcium in the mixed precursor is in a range of (0.2-0.8):(12.4-13.6):1.

4. The method according to claim 1, wherein the organic fuel is one or more selected from the group consisting of alanine, urea, citric acid, maleic hydrazide, and carbohydrazide; and
a molar ratio of the organic fuel to a total of the nickel salt metal precursor, the aluminum salt metal precursor, and the calcium salt metal precursor is in a range of (1-5):1.

5. The method according to claim 1, wherein the drying is conducted at a temperature of 60° C. to 150° C. for 0.5 h to 3 h; and
the calcining is conducted at a temperature of 200° C. to 800° C. for 1 h to 12 h.

6. The method according to claim 1, wherein a flow rate of hydrogen in the flowing hydrogen atmosphere is in a range of 10 mL/min to 50 mL/min; and
the reduction reaction is conducted at a temperature of 700° C. to 950° C. for 1 h to 5 h.

7. A nickel-nickel aluminum spinel-calcium hexaaluminate composite catalyst prepared by the method according to claim 1, wherein the nickel-nickel aluminum spinel-calcium hexaaluminate composite catalyst comprises phases Ni, NiAl₂O₄, and CaAl₁₂O₁₉.

8. The nickel-nickel aluminum spinel-calcium hexaaluminate composite catalyst according to claim 7, wherein in the nickel-nickel aluminum spinel-calcium hexaaluminate composite catalyst, a mass of nickel element accounts for 3% to 10% of a total mass of nickel, aluminum, and calcium elements.

9. A method for dry reforming of methane, comprising the following steps:
feeding the methane and carbon dioxide into a reactor containing the nickel-nickel aluminum spinel-calcium hexaaluminate composite catalyst according to claim 7, and conducting the dry reforming of methane to obtain carbon monoxide and hydrogen as product gases.
